(19) United States
(12) Patent Application Publication
(10) Pub. No.: US 2021/0198790 A1
(43) Pub. Date: Jul. 1, 2021

(54) Apparatus for Generating Hydrogen

(71) Applicant: CGON LIMITED, Watford (GB)

(72) Inventors: Brian David SHEARD, Devon (GB); Mark David FOX, Devon (GB); Clive Spencer MILTON, Devon (GB)

(73) Assignee: CGON Limited, Watford (GB)

(21) Appl. No.: 15/777,566

(22) PCT Filed: Nov. 20, 2015
(86) PCT No.: PCT/GB2015/053547

§ 371 Date: May 18, 2018

(51) Int. Cl. C25B 1/04; C25B 11/02; C25B 11/042; C25B 9/70; C25B 9/63

(52) U.S. Cl. CPC C25B 1/04; C25B 11/02; C25B 9/63; C25B 9/70; C25B 11/042

(57) ABSTRACT

Apparatus (1) for generating hydrogen by means of electrolysis is described. The apparatus (1) includes a housing (2,3) adapted to contain an aqueous electrolyte, in use. A number of electrodes (19, 22) are located within the housing (1) The electrodes (19, 22) comprise a number of cathodes (19) and a number of anodes (22). The electrodes (19, 22) each have a first end portion (21, 18) and each of the electrodes (19, 22) are mounted on a first side wall (24) of the housing at the first end portion (21, 18), so that the first end portions (21, 18) are adapted to be coupled to an electrical power supply (104), in use. The electrodes (19, 22) are in the form of elongate members and are arranged in a linear array such that each anode (22) is separated from an adjacent anode (22) by a cathode (19) and each cathode (19) is separated from an adjacent cathode (19) by an anode (22).

The invention relates to apparatus for generating hydrogen, and especially apparatus for generating hydrogen for supply to an internal combustion engine.

It is known to use a mixture of hydrogen and conventional hydrocarbon fuel in an internal combustion engine in a process known as hydrogen fuel enhancement. Current research suggests that the introduction of hydrogen and oxygen into an internal combustion engine has the potential to produce lower emissions and higher thermal efficiency leading to better fuel economy. Lower emissions can be achieved as the hydrogen and oxygen assist the fossil fuel used to “burn” more efficiently. There are several reasons for this advantage, including:
1. Wide Range of Flammability. Compared to nearly all other fuels, hydrogen has a wider flammability range (4-74% by volume of air versus 1.4-7.6% by volume of air for petrol (gasoline)). This has the advantage of giving a more complete combustion of the fuel mixture by lowering the combustion temperature of the fuel mix, and thereby lowering emissions of pollutants such as nitrous oxides (NOX). The Flammable Range (Explosive Range) is the concentration range of a gas or vapour that will burn (or explode) if an ignition source is introduced. Below the explosive or flammable range the mixture is too lean to burn and above the upper explosive or flammable limit the mixture is too rich to burn.
2. Low Ignition Energy. The amount of energy needed to ignite hydrogen is in the order of a magnitude lower than that needed to ignite petrol for instance (0.02 MJ for hydrogen versus 0.2 MJ for petrol). This helps to ensure ignition of lean mixtures and also gives prompt ignition.
4. Small Quenching Distance. Hydrogen has a small quenching distance (0.6 mm for hydrogen versus 2.0 mm for petrol), which refers to the distance from the internal cylinder wall where the combustion flame extinguishes. Therefore, it is more difficult to quench a hydrogen flame than the flame of most other fuels, such as petrol or diesel. This gives a more complete combustion cycle.
5. High Flame Speed. Hydrogen burns with a high flame speed, allowing for hydrogen in engines to more closely approach the thermodynamically ideal engine cycle (most efficient fuel to power ratio) when the stoichiometric fuel mix is used.
6. High Diffusivity. Hydrogen disperses quickly into air, allowing for a more uniform fuel to air mixture, and a decreased likelihood of major safety issues from hydrogen leaks.

One way in which hydrogen and oxygen for this purpose can be produced is using a regenerative hydrogen fuel cell. This uses the electrolysis of water which causes decomposition of the water (H₂O) into oxygen gas and hydrogen gas due to the electric current passed through the water. The gas mixture produced by this electrolysis process is sometimes referred to as hydroxy gas or Browns gas and is sometimes represented using the chemical symbols HHO.

The basic principle of water electrolysis is that an electrical power source is connected to two electrodes: a negatively charged cathode and a positively charged anode. The electric power source may be provided by a battery, typically a 12 volt or 24 volt battery. The internal combustion engine could be mounted in a stationary environment, such as part of a compressor or power generator. Where the internal combustion engine is located in a stationary environment the power source could be a battery or any other convenient or suitable power source. This could include a transformer and/or AC/DC voltage converter.

Where the internal combustion engine is mounted in a vehicle, the battery would also be typically mounted on the vehicle. The electrodes, which comprise at least one anode and at least one cathode, are placed in water and an electric current is passed through the water. At the negatively charged cathode a reduction reaction takes place with electrons from the cathode being given to hydrogen cat-ions to form hydrogen gas. At the positively charged anode an oxidation reaction occurs generating oxygen gas and giving electrons to the cathode to complete the circuit.

Electrolysis of pure water requires excess energy in the form of over potential to overcome various activation barriers. Without the excess energy the electrolysis of pure water occurs very slowly if at all. Therefore the efficacy of electrolysis of water is usually increased through the addition of an electrolyte (such as a salt, acid or base) and sometimes through the use of electrocatalysts.

Conventional systems use predetermined concentrations of electrolytes mixed in water and the electrolysis reaction is typically driven by an electrical current in the range of 30 amperes to 40 amperes. This relatively high current increases the load on the vehicle battery and reduces the lifetime of the battery and vehicle electrical components. In addition, the use of such high current in the electrolysis process can cause the electrolyte solution in the electrolytic cell to reach undesirably high temperatures.

Another problem with existing hydrogen generators is that if the electrolyte level drops below a threshold level, this can also result in the electrolyte solution reaching undesirably high temperatures. In addition, it is undesirable to expose any of the electrodes to air as this will cause the cell to reduce its efficiency, and in particular, its gas production capabilities as there will be a loss in electrode surface area immersed in the electrolyte.

Accordingly, in accordance with a first aspect there is provided apparatus for generating hydrogen, the apparatus comprising a housing adapted to contain an aqueous electrolyte, in use; an anode and a cathode, both the anode and the cathode being mounted on the housing and each of the anode and the cathode having a first portion that is adapt to be immersed in the aqueous electrolyte, in use, and a second portion adapted to be coupled to an electrical power supply, in use; and the apparatus further comprising an electrolyte level electrode mounted on the housing and having a first portion adapted to be in contact with the aqueous electrolyte, in use, and a second portion adapted to be coupled to the power supply, in use whereby when the aqueous electrolyte falls below a threshold level, such that the electrolyte level electrode is not in contact with the electrolyte, a change in the voltage at the electrolyte level electrode is detected by an electrical circuit.

In accordance with a second aspect, there is provided a method of operating apparatus for generating hydrogen, the apparatus comprising a housing containing an aqueous electrolyte, an anode, a cathode and an electrolyte level electrode, a power supply and an electronic circuit comprising a processor; the power supply being coupled to the anode and cathode to cause a potential difference to be applied to the anode and cathode and to the electrolyte level electrode to cause an electrical current to flow through the electrolyte level electrode and the electronic circuit being coupled to the electrolyte level electrode to detect a change in voltage at the electrolyte level electrode; wherein the method comprises the processor detecting the voltage at the electrolyte level electrode and in response to a detected change in voltage that indicates that the electrolyte level has dropped below a threshold level such that the electrolyte level electrode is not in contact with the aqueous electrolyte, the processor doing at least one of: (i) outputting a warning signal and (ii) switching off the potential difference applied to the anode and cathode.

An advantage of the invention is that by providing an electrolyte level electrode, a drop in the electrolyte level below a threshold level can be detected by the electric circuit.

Preferably, when the processor detects a change in voltage that indicates that the electrolyte solution is below the threshold level, the electric circuit can cause to be generated a low level electrolyte warning signal.

Preferably, the electrical circuit outputs a low level electrolyte warning signal when electrolyte drops below the threshold level and the change in voltage is detected.

Typically, the electrolyte level electrode is located above the other electrodes when the apparatus is in normal use and the electrolyte level electrode is the first electrode to be exposed in the event that the electrolyte level drops.

However, it is possible that the electrolyte level electrode could be mounted at the same level as the other electrodes but shorter than the other electrodes so that when the electrolyte solution drops below the threshold level, the other electrodes are still immersed in the electrolyte solution but the electrolyte level electrode is not immersed.

In one example of the invention, if a change of voltage at the electrolyte level electrode is detected that indicates that the electrolyte solution has dropped below the threshold level, the electrical circuit may turn off power to all the electrodes so that the cell shuts down safely.

Preferably, the detected change in voltage is an increase in voltage as the current through the electrolyte level electrode drops to zero.

Preferably, there are two or more anodes. Preferably, there maybe two or more cathodes. In one example of the invention, there may be a different number of anodes and cathodes. Typically, the electrodes are arranged in a linear array.

Preferably, the linear array of electrodes comprises alternating cathodes and anodes, such that an adjacent pair of cathodes is separated by an anode and an adjacent pair of anodes is separated by a cathode.

Typically the anode and cathode are in the form of an elongate member, such as an elongate rod. Preferably, the surfaces of the anode and cathode have a ridged formation. This has the advantage of improving the efficiency of the electrolysis reaction and the amount of hydrogen gas produced. Typically, where the anode and cathode are elongate rods, the ridged formation may be in the form of a thread formation on the external surface of each elongate rod.

Preferably the anode and/or the cathode may be formed from a non-reactive metal, such as titanium Grade 2 or higher. Typically, the anode has an anti-passivation coating.

In accordance with a third aspect, there is provided apparatus for generating hydrogen, the apparatus comprising a housing adapted to contain a aqueous electrolyte, in use; an anode and a cathode, both the anode and the cathode being mounted on the housing and each having a first portion that is adapt to be immersed in the aqueous electrolyte, in use, and a second portion adapt to be coupled to an electrical circuit, in use, such that potential difference is applied across the anode and the cathode, in use; and the apparatus further comprising an electrolyte level electrode mounted on the housing and having a first portion adapted to be in contact with the aqueous electrolyte, in use, and a second portion adapted to be coupled to the electrical circuit, in use whereby, in use, when the aqueous electrolyte drops below a threshold level such that the electrolyte level electrode is not in contact with the electrolyte, a change in potential at the electrolyte level electrode is detected by the electrical circuit and the electrical circuit generates a low level electrolyte signal.

In accordance with a fourth aspect, there is provided a method of detecting whether an aqueous electrolyte in a hydrogen generating apparatus is above or below a threshold level, the method comprising providing a electrolyte level electrode and an electrical circuit comprising a processor, applying an electrical current through the electrolyte level electrode and detecting the voltage at the electrolyte level electrode, whereby when the electrolyte level drops below the electrolyte level electrode, the processor detects a change in the voltage at the electrolyte level electrode and the processor generating a low level electrolyte signal in response to the change in the voltage.

Preferably, the change in voltage is an increase in the voltage.

Typically, the electrolyte level electrode is located above the other electrodes when the apparatus is in normal use and the electrolyte level electrode is the first electrode to be exposed if the electrolyte level decreases.

Preferably, the apparatus further comprises an impedance in series with the electrolyte level electrode and a voltage is applied across the impedance, the electrolyte level electrode and a cathode, and the potential between the resistor and the electrolyte level electrode is detected by the electrical circuit.

Preferably the impedance comprises a resistor.

Typically, the voltage drop between the electrolyte level electrode and the cathode when the electrolyte contacts the electrolyte level electrode is 50% or less than the voltage applied, and preferably is 25% or less of the voltage applied.

Preferably, when the electrolyte contacts the electrolyte level electrode, the current passing through the resistor, electrolyte level electrode and the cathode is less than 1 A and preferably less than 1 mA and is most preferably less than 0.5 mA. The applied voltage may be the voltage of a power source for the electrical circuit and the power source preferably has a nominal voltage of 12V or 24V. In one example, the current is 0.24 mA, the resistor has a resistance of 56k0 and the applied voltage is in the range of 12.5V to 14V.

Typically, when the electrolyte level drops below the electrolyte level electrode, the voltage detected increases to equal the applied voltage. In this instance the current flowing through the impedance, electrolyte level electrode and cathode drops to 0 A.

In accordance with a fifth aspect, there is provided apparatus for generating hydrogen by means of electrolysis, the apparatus comprising a housing adapted to contain an aqueous electrolyte, in use, and a number of electrodes located within the housing, the electrodes comprising a number of cathodes and a number of anodes, the electrodes each having a first end portion and each of the electrodes being mounted on a first side wall of the housing at the first end portion, so that the first end portions are adapted to be connected to an electrical power supply, in use, and wherein the electrodes are in the form of elongate members and are arranged in a linear array such that each anode is separated from an adjacent anode by a cathode and each cathode is separated from an adjacent cathode by an anode.

Preferably, ends of the electrodes remote from the side on which the electrodes are mounted are located in recesses in an opposite side wall of the housing without penetrating the opposite side wall.

Typically, the apparatus further comprises a vent in a top wall of the housing to enable hydrogen generated to exit the housing, in use.

Typically, the first end portions of each electrode penetrate the first side wall of the housing and the apparatus further comprises a sealing device to provide a substantially water tight seal between the electrodes and the first side wall.

Preferably, the elongate members are in the form of rods. Typically, the elongate members have a ridged formation on their outer surface. Preferably, the ridged formation is in the form of a thread.

Preferably, the electrodes are formed from a non-reactive metal. More preferably, the non-reactive metal is titanium.

Typically, the anodes are coated with an anti-passivation coating. The anti-passivation coating may be one of a mixed metal oxide and a platinum oxide.

Preferably, the electrodes are each mounted on the first side wall of the housing by means of a threaded fastening on the first end portion. Typically, at least the first end portion of each electrode comprises a thread formation to enable the first end portion to be secured to the housing by means of a complimentary threaded fastener which engages with the thread formation on the first end portion to mount each electrode on the first side wall.

Typically, the apparatus further comprises a printed circuit board (PCB) mounted on the outside of the first side wall of the housing and wherein each of the electrodes are electrically coupled to electrical contacts on the PCB by means of the first portion. Preferably, the apparatus further comprises a cover adapted to be coupled to the first side wall to cover the PCB in use.

Preferably, the fifth aspect may be used in combination with one or more of the first to fourth aspects.

In accordance with a sixth aspect, there is provided a fuel cell, the apparatus comprising a housing adapted to contain an electrolyte, in use, and a number of electrodes located within the housing, the electrodes comprising a number of cathodes and a number of anodes, the electrodes each having a first end portion and all being mounted on one section of the housing by means of the first end portion and a printed circuit board (PCB) mounted on the outside of the section of the housing and wherein each of the electrodes are electrically coupled to electrical contacts on the PCB by means of the first portion.

Preferably, the section of the housing is a side wall of the housing. However, alternatively, the section of the housing could be another wall, such as a top wall of the housing.

Typically, the first end portions are adapted to be coupled to an electrical power supply, in use, by means of the PCB.

Preferably, the electrodes are in the form of elongate members and are arranged in a linear array such that each anode is separated from an adjacent anode by a cathode and each cathode is separated from an adjacent cathode by an anode.

The fuel cell may be a conventional fuel cell or a regenerative (or reverse) fuel cell.

Preferably, the sixth aspect may be used in combination with one or more of the first to fifth aspects.

In all aspects, the apparatus may be a regenerative hydrogen fuel cell.

Typically, the electrolyte in all aspects may be in the form of a liquid.

An example of apparatus for generating hydrogen in accordance with the invention will now be described with reference to the accompanying drawings, in which:

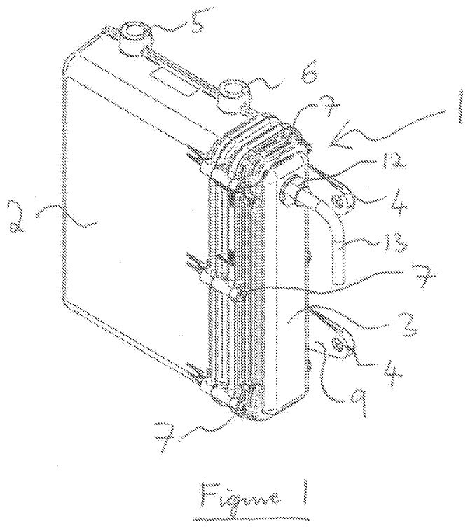

FIG. 1 is a perspective view of a hydrogen generating cell;

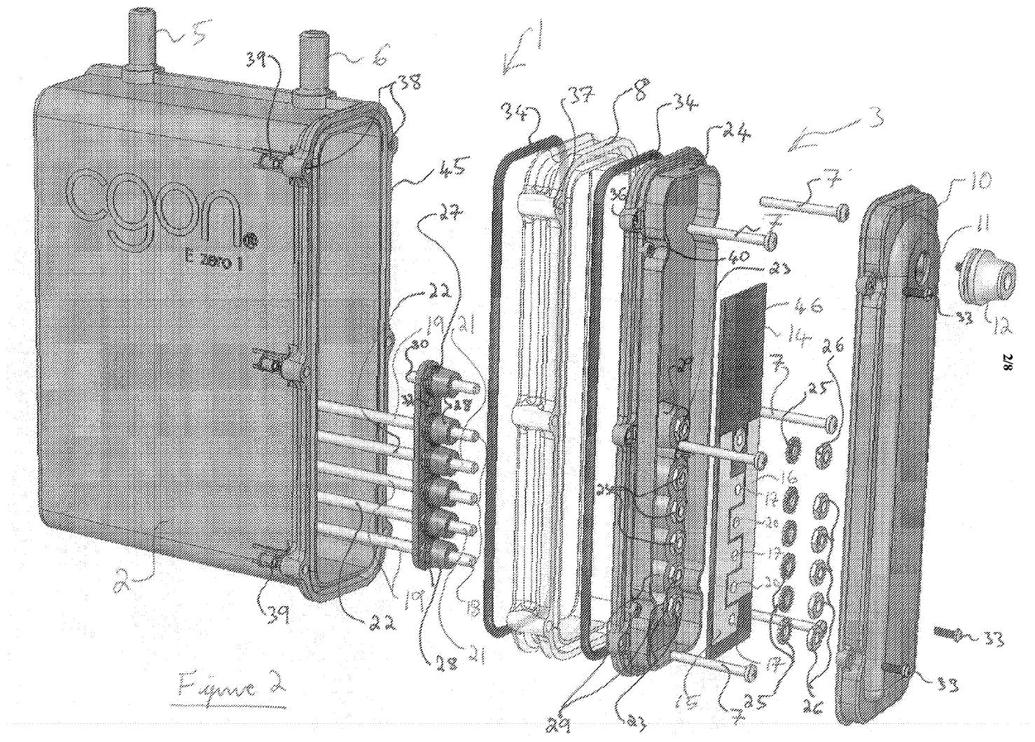

FIG. 2 is an exploded view of the hydrogen generating cell of FIG. 1;

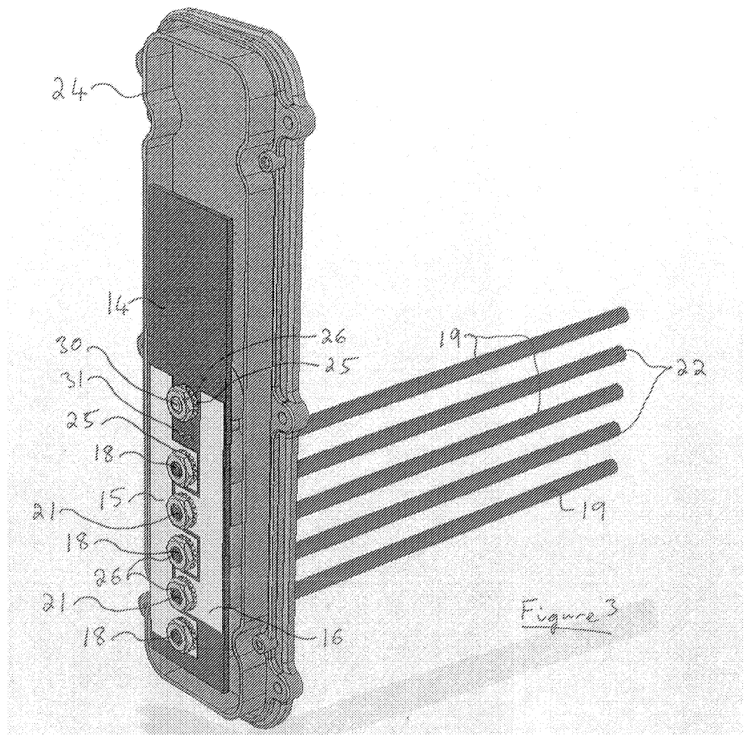

FIG. 3 is a perspective view of a PCB housing with assembled electrodes and printed circuit board which forms part of the hydrogen generating cell of FIG. 1;

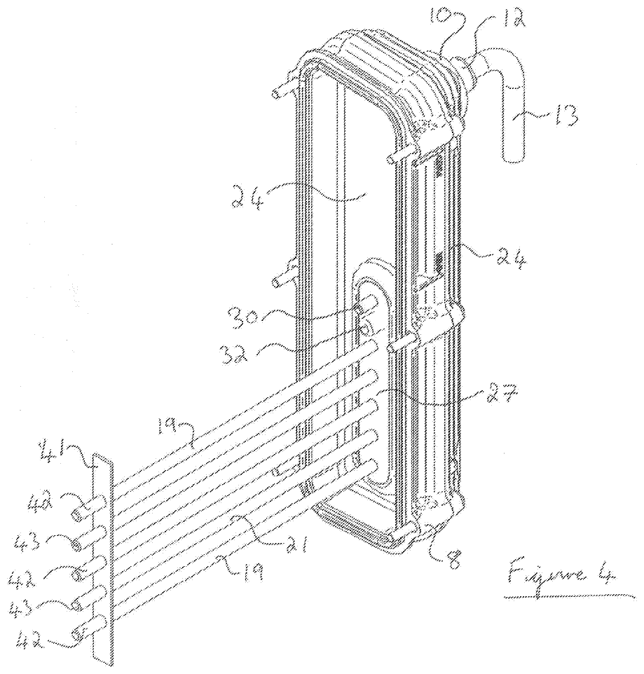

FIG. 4 is a perspective view of an assembled end cap assembly with the electrodes which forms part of the hydrogen generating cell of FIG. 1;

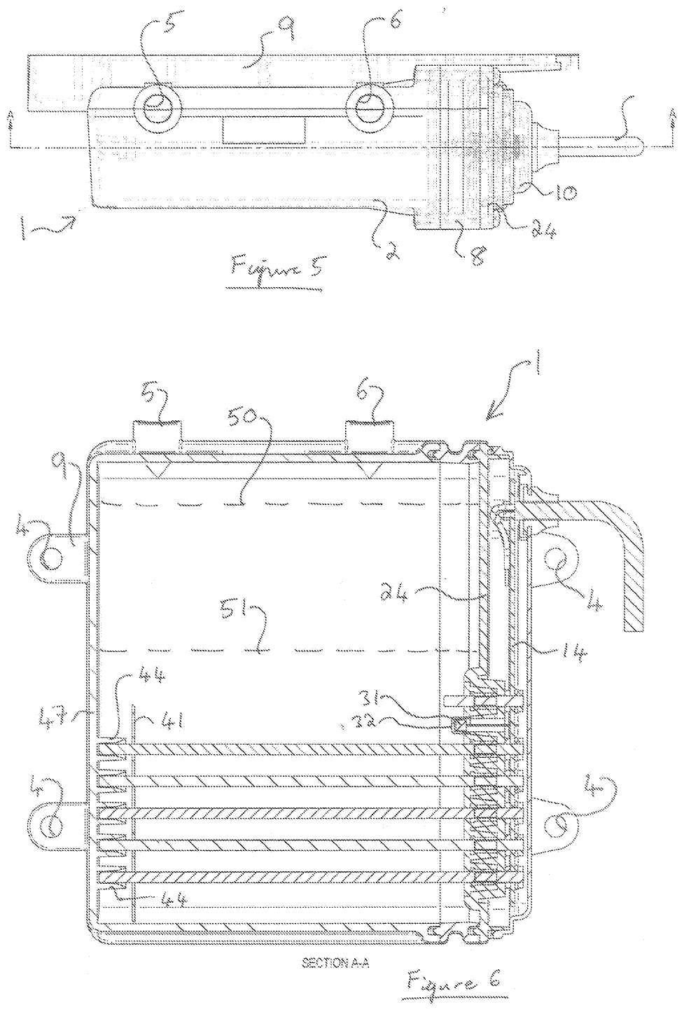

FIG. 5 is a top view of the hydrogen generating cell of FIG. 1;

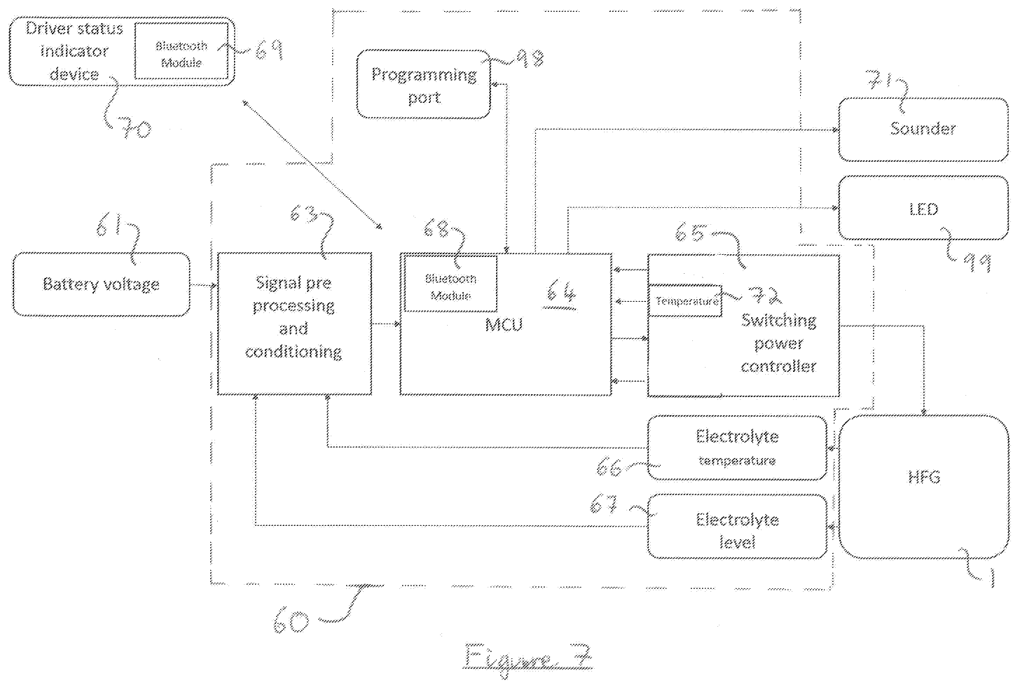

FIG. 6 is a cross-sectional view of the hydrogen generating cell of FIG. 1;

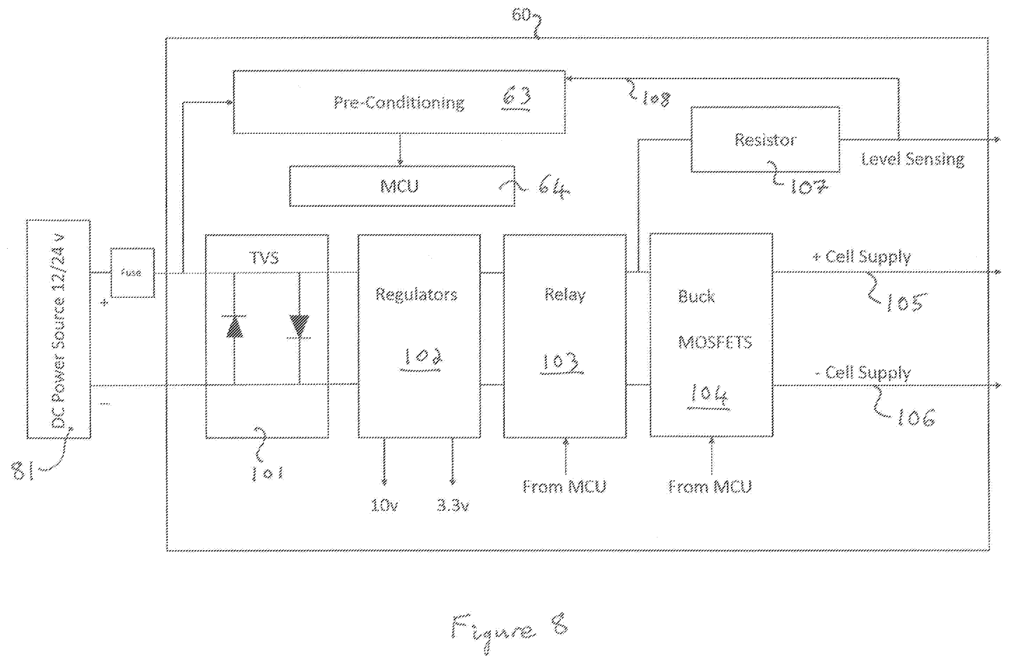

FIG. 7 is a schematic diagram of an electronic control unit for use with the hydrogen generating cell of FIG. 1 showing the signal processing and control components;

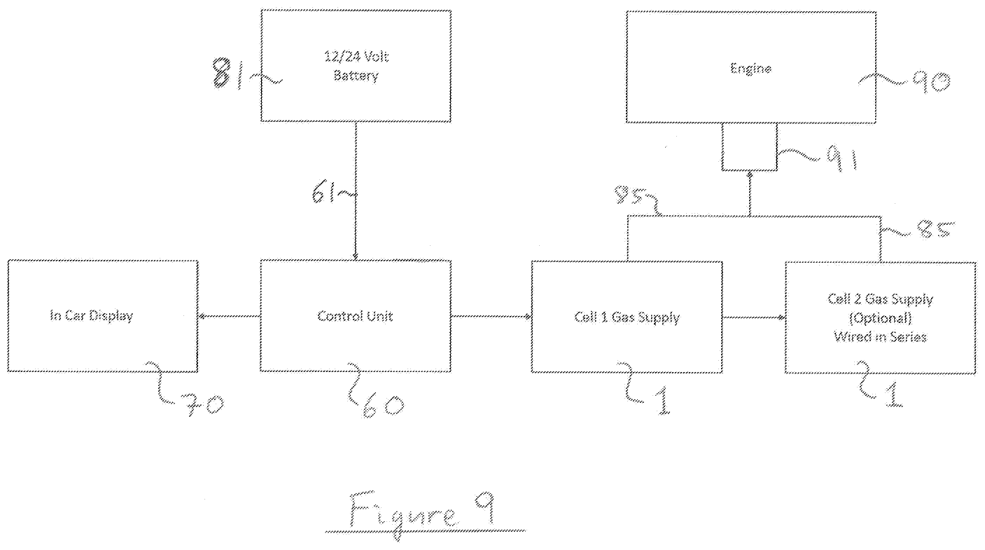

FIG. 8 is a schematic diagram of the electronic control unit showing the power supply components; and

FIG. 9 is a schematic diagram showing the incorporation of the hydrogen generating cell of FIG. 1 and the electronic control unit of FIG. 7 into a vehicle to supply hydrogen to an internal combustion engine.

FIG. 1 shows a hydrogen generating cell 1, sometimes known as a regenerative hydrogen fuel cell, which includes a main housing 2 and an end cap assembly 3. The hydrogen generating cell 1 includes an integrated mounting bracket 9 with four mounting points 4. Two mounting points 4 are located on either side of the cell 1. Located at the top of the main housing 2 are two ports 5, 6. One of the ports 5 can be connected by a pipe 85 to an air intake 91 of an internal combustion engine 90 (see FIG. 9) and the other port 6 can be used to top-up liquid within the cell 1. The end cap assembly 3 is fixed to the main housing 2 by means of removable bolts 7.

An exploded view of the cell 1 is shown in FIG. 2 where it can be seen that the end cap assembly 3 comprises an outer end cap 10 having a hole 11 into which a rubber sleeve 12 is fitted. The rubber grommet/sleeve 12 and hole 11 permit entry of an electrical cable 13 from an electronic control unit 60, shown in FIG. 7 and which will be explained in more detail below.

The end cap assembly 3 also includes a printed circuit board (PCB) 14 having a cathode terminal electrode 15 and an anode terminal electrode 16. The cathode terminal electrode 15 has three holes 17 through which ends 18 of cathodes 19 penetrate. Similarly, the anode terminal electrode 16 has two holes 20 through which ends 21 of anodes 22 can penetrate.

The cathodes 19 and the anodes 22 are formed from threaded metal rods which are preferably titanium, and most preferably grade 2 titanium. In addition, the anodes 22 have an anti-passivation coating such as a mixed metal oxide or platinum oxide coating. However, the anti-passivation coating could be any other suitable anti-passivation coating. The ends 18, 21 of the cathodes 22 and anodes 19, respectively, are screwed into captive nuts 23 mounted on PCB housing 24, the ends 18, 21 are screwed through the nuts 23 until the ends 18, 21 protrude from the captive nuts 23 such that the ends 18, 21 can be inserted through holes 17, 20 respectively in the PCB 14. Washers 25 and nuts 26 are then placed over the ends 18, 21 to secure the cathodes 19 and the anodes 22 to the PCB housing 24 and to secure the PCB 14 to the ends 18, 21 such that the ends 18, 21 contacted the respective PCB contact plates 17, 16.

Before inserting the ends 18, 21 into the PCB housing 24, the cathodes 19 and anodes 22 are inserted through an electrode seal 27 which has protruding portions 28 that are inserted into corresponding recesses 29 formed in the PCB housing 24. The frustoconical shape of the protruding portions 28 and the complementary shape of the recesses 29 compresses the protruding portions 28 against the inside of the recesses 29, as the nuts 26 are screwed onto the ends 18, 21 and tightened. This in turn compresses portions 28 against the outsides of the cathodes 18 and anodes 21 to create a water tight seal. This helps to seal the electrodes to the PCB housing 24 and helps to prevent leakage of electrolyte within the cell 1 through the PCB housing 24 where the ends 18, 21 of the cathodes 19 and anodes 22 penetrate the housing 24. The presence of the washers 25 and the nuts 26 that are threaded on to the ends 18, 21 help to ensure that electrical contact is made between the cathodes 19 and the cathode terminal electrode 15 and between the anodes 19 and the anode terminal electrode 16.

FIG. 3 shows PCB housing 24 with the anodes 19, the cathodes 22 and the PCB 14 assembled onto the PCB housing 24.

In addition to the cathodes 22 and the anodes 19, a level sensing electrode 30 is also mounted on the electrode seal 27 and secured to the PCB housing 24 with a captive nut 23 and a further washer 25 and nut 26. The level sensing electrode 30 is also preferably formed from a threaded rod, such as titanium rod, and is also preferably grade 2 titanium.

Furthermore, a thermistor 31 is connected to the PCB board 14 and inserted into recess 32 in the electrode seal. The thermistor 31 is better shown in FIG. 6 where it can be seen that recessed section 32 of the electrode seal 27 is closed so that electrolyte within the cell 1 does not directly contact the thermistor 31.

After the cathodes 19 and anodes 22 are secured to the PCB housing 24 together with the PCB 14, the level sensor electrode 30 and the thermistor 32, the electric power cable 13 connected to the PCB 14 is threaded through hole 11 the end cap 10 and through the hole in the rubber grommet/sleeve 12 which is fitted into the hole 11 in the end cap 10. The end cap 10 is then fixed to the PCB housing 24 using the bolts 33 which are screwed into captive nuts 40 on the PCB housing 24. The assembled PCB housing and end cap assembly is shown in FIG. 4 also with spacer 8 mounted on the PCB housing 24 using a rubber seal 34. Another seal 34 is located on the opposite side of the spacer 8 from the PCB housing 24 and ready to be fixed to the main housing 2. Also shown in FIG. 4 is a spacer element 41 which is slid onto the ends of the cathodes 19 and anodes 22 to keep the ends of the cathodes 19 and anodes 22 that are remote from the PCB housing 24 in spaced apart relation to each other.

As shown in FIG. 2, the end cap 10 is attached to the PCB housing 24 using screws 33 and the spacer 8 is sandwiched between the end cap assembly 3 and the housing 1. The two rubber seals 34 seal the spacer to the main housing 2 and to the PCB housing 24. The spacer 8 is preferably transparent or translucent to permit a visual inspection of the liquid electrolyte level within the assembled cell 1. The PCB housing 24, spacer 8 and the housing 2 are secured to each other by means of bolts 7 which pass through holes 36 in the PCB housing 24, holes 37 in the spacer 8 and holes 38 in the housing 2 and secured by brass nuts 39. One of the advantages of using bolts 7 and nuts 39 is that cell 1 can be disassembled for maintenance and servicing, if necessary.

In the cell 1 shown the spacer 8 has a width of 15 mm. However, different sized spacers can be used to create cells with a larger or smaller volume of electrolyte and longer or shorter electrodes. For example, if the cell size is increased by 100 mm then the length of the titanium bars will increase from 158 mm to 258 mm to accommodate the increase in spacer size. For example, possible alternative larger width sizes for the spacer 8 could be 20 mm, 40 mm, 60 mm, 80 mm or 100 mm. However, these are only examples and any suitable width size could be used. The use of a larger spacer 8 has the advantage of enabling longer electrodes to be used which increases the surface area available for electrolysis, thereby increasing the amount of hydroxy gas generated for a single cell. Hence, this could be used in applications with larger engine sizes where more hydroxy gas is required and may have the advantage of enabling a single cell to be used where otherwise two cells would be required.

During assembly of the cell, the cathodes 19 and the anodes 22 are inserted into the housing 2 and ends 42 of the cathodes 19 and ends 43 of the anodes 22 adjacent to the spacer 41 are inserted into recessed apertures 44 formed on the inside side wall of the housing 2, as shown in FIG. 6. The spacer 41 helps to maintain the correct spacing between the ends 42, 43 to aid insertion of the ends 42, 43 into the apertures 44 in the side wall of the housing 2. When the cathodes 19 and anodes 22 are fully inserted into the housing 2 and the spacer 8 with seal 34 butts against flange 45 of the housing 2, the PCB housing and end cap assembly together with the spacer 8 are secured to the housing 2 using the bolts 7.

FIG. 5 shows a top view of the cell 1 with the incorporated mounting bracket 9 located on the back of the cell 1.

FIG. 6 is a cross sectional view through the cell 1 along the line AA shown in FIG. 5. After assembly, the cell 1 can be filled with water based electrolyte solution through either of the holes 5, 6. Broken line 50 indicates typical preferred maximum electrolyte solution level and the broken line 51 indicates a typical preferred minimum level for the electrolyte solution in cell 1.

The electrolyte solution introduced into the cell 1 is predominantly water, preferably distilled water, and most preferably double distilled water, with an electrolyte added. The electrolyte added can be any suitable electrolyte, such as any soluble salt, acid or base. A preferred electrolyte is potassium hydroxide or potassium carbonate. However, in the example of the invention described the electrolyte is potassium hydroxide.

As mentioned above, the power cable 13 is attached to the electronic control unit 60 (see FIG. 7). The control unit 60 is an enclosure of extruded aluminium or any other heat dispersing material and contains all the components shown within the control unit 60 in FIGS. 7 and 8. The enclosure is preferably splash proof but could be fully waterproofed for certain applications, such as for off-road vehicles, for marine environments or other hostile environments. Because the enclosure is from aluminium which is a conductor and therefore forms a Faraday cage, it effectively screens the electronic components within the enclosure from external electro-magnetic radiation and also prevents any electro-magnetic radiation from the components and circuitry within the enclosure penetrating outside the enclosure and interfering with any electrical or electronic components or circuitry outside the enclosure. The enclosure is also designed to dissipate heat from components within the enclosure, such as from switching power controller 65.

The electronic control unit effectively performs two functions: firstly to provide a signal processing and control function using the components and circuitry illustrated schematically in FIG. 7; and secondly to provide a power supply function for the cell 1 using the components and circuitry illustrated schematically in FIG. 8.

The electronic control unit 60 receives a power supply from a vehicle battery 61 located in the vehicle, which may be a 12 volt or 24 volt battery. The voltage signal is input into a signal processing and conditioning unit 63, as shown in FIG. 7. The unit 63 is used to process incoming signals to the control unit 60, such as the battery voltage signal 61, electrolyte temperature signal 66 and electrolyte level signal 67. The unit 63 scales the signals to between 0V to 5V, filters the signal and smooths the signals before outputting them to a microcontroller (MCU) 64, such as an Amtel microcontroller.

The output from the microcontroller 64 is then passed to switching power controller 65 to control power supply to the cell 1.

FIG. 8 shows the power supply circuit. The control unit 60 is electrically coupled to the battery 81 so that power from from the battery 81 is fed to a transient voltage suppressor 101 that provides over and reverse voltage protection for the other components of the control unit 60, for example, to provide protection from undesirable voltage spikes, such as a load dump.

The power is then fed from the TVS 101 to regulators 102. The circuit uses two linear regulators 102. One of the regulators is used to derive a 10V power supply to drive power MOSFETs (metal oxide semiconductor field effect transistors) and buck power supply 104, sounder 71 and relay 103. The other regulator is used to derive a 3.3V power supply to drive the rest of the circuit. The microcontroller 64 is powered directly by the 3.3V supply so that the microcontroller 64 is powered up when a suitable power source (such as battery 81) is connected to the unit 60, irrespective of whether an engine is running. The purpose of the relay 103 is two-fold: firstly to isolate the input from the output (primarily for fault conditions); and secondly to provide further protection to the output circuit from unwanted transient voltages. The relay is controlled by an output from the microcontroller 64.

When the relay is switched on by the microcontroller 64, it provides power to the high side/low side MOSFET drive to form a synchronous buck power supply which will yield conversion efficiency's in excess of 90% or more which reduces the heat dissipation required by the aluminum enclosure encasing the control unit 60.

When the microcontroller is powered on by connection of the unit 60 to a power source, such as the battery 81, the microcontroller 64 executes a pre-installed boot loader program, which is updatable via the communications interface (programming port) 98. This allows for firmware fixes and upgrades as and when required during the life cycle of the control unit 60 and cell 1.

When power is applied to the unit 60 for the first time (for example, by connecting the unit 60 to the battery 81) the program performs a check upon the connected cell 1 to ensure it is operating within expected parameters this includes ensuring all the electrodes 19, 22, 30 are under the electrolyte, If the electrolyte were excessively low then an abnormally low current would flow which would be detected by a high voltage at electrolyte level electrode 30, as described below, and a low electrolyte warning created. From then on the unit 60 waits for an operating (running engine) voltage to be detected. As explained elsewhere, the operating voltage is typically higher than the nominal battery voltage so that the battery will charge while the engine is running. If no operating voltage is detected, that is only a nominal battery voltage is detected, the program will stay in a loop continually checking for the presence of an operating voltage. When an operating voltage is detected then the unit 60 will provide appropriate display outputs to an installer of the unit 60 via a terminal session through the port 98. If an operating voltage is detected the unit 60 will attempt to become active and provide electrical current to the cell 1 to produce an electrolysis reaction to generate hydrogen and oxygen gas. Again upon activation the program will check to see if the cell 1 is inside normal operating parameters such as temperature and electrolyte level. If not the activation will be aborted and LED 99 and sounder 71 will indicate an error or fault condition.

If the parameters are within normal operating limits, the unit 60 will become active and will fall into a control loop until operating voltage is not detected or until an out of range event occurs. Inside the control loop the microcontroller 64 via its embedded program monitors all the acquired data and drives the cell 1.

In the case of the battery signals 61, after the microcontroller 64 receives them from the pre-processing and conditioning unit 63, the micro-controller first converts the analogue battery voltage signals to a digital format. After the battery voltage signals have been converted to a digital format the microcontroller 64 uses them to control switching power controller 65 (including the relay 103 and the buck power supply with MOSFETs 104) to supply power to the cell 1 on power supply lines 105, 106 in order to drive the cell.

The cell 1 operates on the basis of a conventional electrolysis unit with a positive voltage being applied to the anodes 22 and a negative voltage applied to the cathodes 19. The potential between the cathodes 19 and the anodes 22 in combination with the electrolyte solution causes a current to flow between the anode and cathode through the electrolyte solution. This causes hydrogen to be generated at the negative cathodes 19 and oxygen gas to be formed at the positive anodes 22 by electrolysis that disassociates the water into its component parts of hydrogen gas and oxygen gas to form hydroxy gas (HHO).

A side effect of the electrolysis reaction is that heat is generated and the thermistor 31 is used to monitor the temperature of the electrolyte solution within the cell 1. The output from the thermistor, the electrolyte temperature signal 66 is fed back to the control unit 60 via the PCB 14 and the cable 13 which feeds the signal to the signal processing and conditioning unit 63 where it is smoothed. The unit 63 then outputs the smoothed signal to the microcontroller 64 that converts the analogue temperature signal from the thermistor 31 into a digital signal and uses it to monitor the temperature of the electrolyte to ensure it does not overheat.

In addition, the microcontroller 64 controls the relay 103 to supply a small current through a resistor 107 to the electrolyte level electrode 30. The current supplied is typically less than 1 A, preferably less than 1 mA and is most preferably less than 0.5 mA. In the example described, the current is 0.24 mA and the resistor has a resistance of 56k0.

The potential at the electrode 30 is monitored by the microcontroller 64 via line 108 and the pre-processing and conditioning unit 63. When the electrolyte is above the level of the electrolyte level electrode 30, the electrolyte conducts the current to the nearest cathode 19 and the potential at the electrode 30 is proportional to:

R(e)/(R(e)+R(r)

Where R(e) is the resistance of the electrolyte and R(r) is the resistance of the resistor in the power controller 65. As the cathodes are grounded, and if the voltage applied by the power controller 65 is the battery voltage of, for example, 13.7V, the voltage detected at the electrode 30 is of the order of approximately 2V.

However, if the electrolyte level drops below the electrode 30, the electrode 30 is then not in contact with the electrolyte and is in air. Therefore, the electrical connection between the electrode 30 and the cathode 19 is broken and there is no current flowing through the electrolyte. When there is no current flow through the electrolyte and the voltage at the electrode 30 is the battery voltage of 13.7V.

The voltage detected at the electrode 30 represents the electrolyte level signal 67 and is fed to the processing and conditioning unit 63 which smooths the signal and then outputs it to the microcontroller 64. The microcontroller 64 converts the detected voltage signal to a digital signal which is then monitored by the microcontroller 64.

As explained above when there is sufficient electrolyte in the cell 1 to cover the electrolyte level electrode 30, the voltage detected at the electrode 30 will be approximately 2V. However, if the electrolyte level falls below the minimum level 51 and below the level of the electrolyte level electrode 30, the voltage detected will increase to the battery voltage of approximately 13.7V. The microcontroller 64 detects this change and therefore, if the voltage at the electrode 30 rises to the battery voltage, or above a suitable threshold between 2V and the battery voltage, this indicates that the electrolyte solution level is too low. The microcontroller 64 then generates and outputs a low electrolyte level warning signal to Bluetooth module 68 which transmits the warning signal to a Bluetooth module 69 on a driver or operator status indicator device 70 to indicate to a driver or operator that there is a fault condition and that maintenance is required. In particular, that the cell must be topped up with more electrolyte solution through port 6. It is also possible that the microcontroller 64 as an alternative, or an addition, can activate an audible signal through loudspeaker device 71.

In this situation, the microcontroller will normally still drive the cell 1 via the switching power controller 65 for a given period of time, such as 40 hours. If no corrective action is performed within the given time period the microcontroller unit 64 will switch the switching power controller 65 to stop providing driving current to the cell 1 until it is reset by a suitable technician and the necessary corrective action is taken to refill the electrolyte solution within the cell 1. This helps to minimise the risk that the cell is damaged by low electrolyte level and also helps to ensure that the cathodes 19 and anodes 22 are always covered with electrolyte solution to optimise electrolysis and hydrogen gas production. If the cathodes 19 and the anodes 22 are not completely covered then this will compromise the efficiency of the electrolysis process.

The hydrogen generating cell 1 and the control unit 60 can be used with any suitable internal combustion engine 90 (see FIG. 9), such as a diesel engine or a petrol (gasoline) and LPG engine.

The internal combustion engine 90 can be mounted in a fixed location or in a location where the engine is not intended to be moved when in use, such as on a compressor or electrical power generator.

Alternatively, the engine 90 could form part of a vehicle, such as a land vehicle, watercraft or aircraft. Examples of possible vehicles are automobiles, motorcycles, vans, lorries, trucks, tractors, trains, boats, ships, submarines, aeroplanes or any other vehicle that can use an internal combustion engine. In this case, the cell 1 and electronic unit 60 are fitted in a suitable location in the vehicle. For example, this may be the engine bay of a vehicle.

It is preferable that the cell 1 is located close to a source of air flow which is useful in helping to cool the cell 1 and minimise the risk of the electrolyte solution within the cell 1 overheating. The control unit 60 can be located in any suitable location but is preferably located within the engine bay and typically, close to the battery or other power supply.

The status indicator device 70 is preferably located on a dashboard for example, of a vehicle or on a display or operator's panel associated with the engine. Alternatively, the status indicator device 70 is preferably in another location where it is easily visible by an operator or driver of the vehicle or operator of the engine or of the equipment that the engine powers.

After the cell 1 is installed in a vehicle, or on equipment using the engine, using the mounting bracket 9, a pipe 85 (see FIG. 9) is connected to the hole 5 and the other end of the pipe is connected to an air inlet 91 of the internal combustion engine 90.

In use, the control unit 60 is continuously powered by the battery 81 and when the engine is not running is in a continuous loop checking for an increase in the voltage signal 61 from battery 81. When the engine 90 is started, a running engine typically charges the battery via an alternator and to do so it must raise the voltage applied to the battery to greater than the nominal voltage of the battery. For example, if the nominal battery voltage is 12 volts, the voltage applied to the battery to charge it is normally approximately 13.7 volts. The control unit 60 and in particular, the microcontroller 64 detects this increase in battery voltage when an engine is started by means of the battery voltage signal 61 which the microcontroller 64 receives through the signal pre processing and conditioning electronic unit 63. In this way, by monitoring the battery voltage, the microcontroller 64 knows when the engine has started and can then control the switching power controller 65 (relay 103 and buck power supply with MOSFETs 104) to apply power to the cell 1 to drive the cell so that electrolysis occurs within the cell to generate hydrogen and oxygen gas. The hydrogen and oxygen gas that is generated at the cathodes 19 and the anodes 21 then bubbles through the electrolyte to the top of the unit and vents through the hole 5 into the pipe 85 and is fed to the air inlet 91 of the engine. When an internal combustion engine runs, air is sucked in through the air inlet 91 and the flow of air through the air inlet 91 creates a venturi effect to draw hydroxy gas mixture through the pipe 85 from the cell 1 into the air inlet 91 so that the hydroxy gas mixes with the air being drawn in through the air inlet 91 and enters the engine combustion chamber.

As the switching power controller 65 generates heat a temperature sensor 72 is incorporated into the switching power controller 65 and the output from the temperature sensor 72 is output to the micro controller unit 64 so that the micro controller unit 64 can monitor the temperature of the switching power controller 65 for system protection purposes.

A schematic diagram showing the incorporation of the cell 1 and the control unit 60 into an internal combustion engine 90 is shown in FIG. 9, where it can be seen that the control unit 60 receives an input from the vehicle battery 61 and controls the cell 1 (or optionally two cells 1). The control unit can also output signals to an in-vehicle status indicator 70 to indicate fault conditions to a driver or operator of the vehicle. The status indicator 70 can also be used to indicate to the driver or operator of the engine that the control unit 60 and the cell 1 is working normally.

The microcontroller unit 64 is also connected to an LED 10. The LED 10 can be activated by the microcontroller 64 to provide a visual indication of an error condition.

An advantage of the invention is that by providing anodes 22 and cathodes 19 that are mounted on a side of the cell 1, it is possible to ensure that the cathodes 19 and anodes 22 are completely submerged in electrolyte solution to optimise efficiency of the electrolysis action and changes in the electrolyte level can be tolerated without exposing surfaces of the cathodes and anodes, thereby maintaining improved electrolysis efficiency. In addition, as the cathodes 19 and the anodes 22 only penetrate one side wall of the housing of the cell 1, the complexity of manufacturing and assembly of the cell 1 is reduced and potential for leakage of the electrolyte from the cell is also reduced by the opposite ends 42, 43 of the cathodes 19 and anodes 22, respectively, not penetrating the opposite side wall 47 of the housing 2. However, relative movement of the remote ends of the cathodes 19 and anodes 22 relative to each other due to engine and/or vehicle vibration is reduced due to the locating the recesses positioned in the opposite side wall with holds the remote ends of the electrodes in position.

Furthermore, the electrolyte level sensor electrode 30 minimises the risk of the electrolyte level dropping to a level at which efficiency and operation of the electrolysis reaction within the cell 1 is compromised by being able to generate an electrolyte level warning signal before the electrolyte level drops to a level at which efficient operation of the cell is compromised.

1-27. (canceled)

28. Apparatus for generating hydrogen by means of electrolysis, the apparatus comprising a housing adapted to contain an aqueous electrolyte, in use, and a number of electrodes located within the housing, the electrodes comprising a number of cathodes and a number of anodes, the electrodes each having a first end portion and each of the electrodes being mounted on a first side wall of the housing at the first end portion, so that the first end portions are adapted to be connected to an electrical power supply, in use, and wherein the electrodes are in the form of elongate members and are arranged in a linear array such that each anode is separated from an adjacent anode by a cathode and each cathode is separated from an adjacent cathode by an anode.

29. Apparatus according to claim 28, wherein the ends of the electrodes remote from the side on which the electrodes are mounted are located in recesses in an opposite side wall of the housing without penetrating the opposite side wall.

30. Apparatus according to claim 28, wherein the first end portions of each electrode penetrate the first side wall of the housing and the apparatus further comprises a sealing device to provide a substantially water tight seal between the electrodes and the first side wall.

31. Apparatus according to claim 28, wherein the elongate members are in the form of rods.

32. Apparatus according to claim 28, wherein the elongate members have a ridged formation on their outer surface.

33. Apparatus according to claim 32, wherein the ridged formation is in the form of a thread.

34. Apparatus according to claim 28, wherein the electrodes are formed from a non-reactive metal.

35. Apparatus according to claim 28, wherein the anodes are coated with an anti-passivation coating.

36. Apparatus according to claim 35, wherein the anti-passivation coating is one of a mixed metal oxide and a platinum oxide.

37. Apparatus according to claim 28, wherein the electrodes are each mounted on the first side wall of the housing by means of a threaded fastening on the first end portion.

38. Apparatus accordingly to claim 37, wherein at least the first end portion of each electrode comprises a thread formation to enable the first end portion to be secured to the housing by means of a complimentary threaded fastener which engages with the thread formation on the first end portion to mount each electrode on the first side wall.

39. Apparatus according to claim 28, further comprising a printed circuit board (PCB) mounted on the outside of the first side wall of the housing and wherein each of the electrodes are electrically coupled to electrical contacts on the PCB by means of the first end portion.

40. Apparatus for generating hydrogen, the apparatus comprising a housing adapted to contain a aqueous electrolyte, in use; an anode and a cathode, both the anode and the cathode being mounted on the housing and each having a first portion that is adapt to be immersed in the aqueous electrolyte, in use, and a second portion adapt to be coupled to an electrical circuit, in use, such that potential difference is applied across the anode and the cathode, in use; and the apparatus further comprising an electrolyte level electrode mounted on the housing and having a first portion adapted to be in contact with the aqueous electrolyte, in use, and a second portion adapted to be coupled to the electrical circuit, in use whereby, in use, when the aqueous electrolyte drops below a threshold level such that the electrolyte level electrode is not in contact with the electrolyte, a change in potential at the electrolyte level electrode is detected by the electrical circuit and the electrical circuit generates a low level electrolyte signal.

41. Apparatus according to claim 40, wherein the electrolyte level electrode is located above the other electrodes when the apparatus is in normal use and the electrolyte level electrode is the first electrode to be exposed if the electrolyte level decreases.

42. Apparatus according to claim 40, wherein the apparatus further comprises an impedance in series with the electrolyte level electrode and a voltage is applied across the impedance, the electrolyte level electrode and a cathode, and the potential between the impedance and the electrolyte level electrode is detected by the electrical circuit.

43. Apparatus for generating hydrogen by means of electrolysis, the apparatus comprising a housing adapted to contain an electrolyte, in use, and a number of electrodes located within the housing, the electrodes comprising a number of cathodes and a number of anodes, the electrodes each having a first end portion and all being mounted on one section of the housing by means of the first end portion and a printed circuit board (PCB) mounted on the outside of the section of the housing and wherein each of the electrodes are electrically coupled to electrical contacts on the PCB by means of the first portion.

44. Apparatus according to claim 43, wherein the first end portions are adapted to be coupled to an electrical power supply, in use, by means of the PCB.

45. Apparatus according to claim 43, wherein the electrodes are in the form of elongate members and are arranged in a linear array such that each anode is separated from an adjacent anode by a cathode and each cathode is separated from an adjacent cathode by an anode.

46. Apparatus according to claim 43, wherein the electrodes are mechanically mounted on the PCB.

47. Apparatus accordingly to claim 46, wherein t least the first end portion of each electrode comprises a thread formation to enable the first end portion to be secured to the one section of the housing and the PCB by means of a complimentary threaded fastener which engages with the thread formation on the first end portion to mount each electrode on the one section and the PCB.
